(19) United States
(12) Patent Application Publication
(10) Pub. No.: US 2026/0360259 A1
(43) Pub. Date: Nov. 12, 2026

(54) MULTIPLE MISSIONS PROGRESSION MONITORING

(71) Applicant: Wisk Aero LLC, Mountain View, CA (US)

(72) Inventors: Davide Pierini, Montreal (CA); Vivien Zhang, Mountain View, CA (US)

(73) Assignee: Wisk Aero LLC, Mountain View, CA (US)

(21) Appl. No.: 19/672,306

(22) Filed: May 8, 2026

Related U.S. Application Data
(60) Provisional application No. 63/802,387, filed on May 8, 2025.

(51) Int. Cl. G08G 5/23; G08G 5/22; G08G 5/57; G08G 5/59

(52) U.S. Cl. CPC G08G 5/23; G08G 5/22; G08G 5/57; G08G 5/59

(57) ABSTRACT

Systems, methods, and non-transitory, processor-readable media may provide for multiple missions progression monitoring for 1:n automated vehicles operations. Operational data corresponding to a set of one or more remotely supervised autonomous aircraft may be received. A set of active route composites may be generated based on the operational data. A graphical representation may be generated for each active route composite among the set of active route composites. Each graphical representation may include an aircraft identifier of a corresponding autonomous aircraft among the set of one or more remotely supervised autonomous aircraft and a representation of an active route associated with the autonomous aircraft. The graphical representations for the set of active route composites may be displayed. The graphical representation may be updated to indicate a current progression of the corresponding autonomous aircraft along the representation of the active route. The graphical representations may be visually uniform.

### CROSS-REFERENCE TO RELATED APPLICATION

This application claims benefit under 35 USC § 119(e) to U.S. Provisional Patent Application No. 63/802,387 filed May 8, 2025, the disclosure of which is incorporated by reference herein in its entirety for all purposes.

### TECHNICAL FIELD

This disclosure generally relates to aircraft monitoring and control, and more particularly to multiple missions progression monitoring for 1:n automated vehicles operations.

### BACKGROUND

Advancements in autonomous vehicles technology may be introducing a new paradigm where automation is progressively replacing the human operator in performing the main flight functions. In turn, this may allow a single operator or a few operators to monitor multiple vehicles simultaneously. How to safely enable this new paradigm may be referred to as the m:N problem, where m=number of operators and N=number of vehicles.

From a human factors perspective, one of the consequences of having a single operator responsible for overseeing multiple highly automated vehicles may be that human cognitive capabilities are critically challenged. Even during nominal operations, the amount and the complexity of the information that must be continuously attended and interpreted in order to understand what the next tasks are and be ready to perform them (i.e., situation assessment) may easily exceed human capabilities. The situation assessment process may be an essential process allowing the operator to gain sufficient understanding of the state of each mission and how these states relate to each other in order to understand what are the tasks that must be performed next or what should be expected in the near future from other actors involved in the mission (automated and/or other humans).

At a very high level, the operator may have to 1) continuously process an amount of information close to or exceeding human working memory capabilities to assess the situation, 2) frequently switch between different loosely related tasks, and 3) potentially deal with multitasking and its consequences, such as conflicts between cognitive resources, interruptions, and time pressure. Moreover, continuously performing the same tasks in relation to different missions and interruption may likely cause different types of memory errors, such executing a task twice for the same mission, forgetting to perform a task, or resuming a task from the wrong step. At higher operational tempos, because of such continuous workload, the operator may also experience mental fatigue which in turn affects their overall performance. These cognitive issues may also represent an obstacle to type certification as human factors regulatory requirements specifically mention that, while participating in the operations, the operator shall never experience excessive workload or make critical errors.

Thus, there is a need for solutions that address these challenges and problems. This and other needs are addressed by the present disclosure.

### BRIEF SUMMARY

Certain embodiments of the present disclosure relate generally to generally relates to aircraft monitoring and control, and more particularly to multiple missions progression monitoring for 1:n automated vehicles operations.

In one aspect, a system to facilitate supervising aircraft operations of remotely supervised autonomous aircraft may include one or more processing devices and memory communicatively coupled with and readable by the one or more processing devices and having stored therein processor-readable instructions which, when executed by the one or more processing devices, cause the system to perform one or a combination of the following operations. Operational data corresponding to a set of one or more remotely supervised autonomous aircraft may be received. A set of one or more active route composites may be generated based at least in part on the operational data. A graphical representation may be generated for each active route composite among the set of one or more active route composites. The graphical representation may include an aircraft identifier of a corresponding autonomous aircraft among the set of one or more remotely supervised autonomous aircraft and a representation of an active route associated with the corresponding autonomous aircraft. The graphical representations for the set of one or more active route composites may be displayed on a display device. Each graphical representation may be updated periodically or in real time to indicate a current progression of the corresponding autonomous aircraft along the representation of the active route, where the graphical representations are visually uniform.

In another aspect, a method to facilitate supervising aircraft operations of remotely supervised autonomous aircraft may include one or a combination of the following. Operational data corresponding to a set of one or more remotely supervised autonomous aircraft may be received. A set of one or more active route composites may be generated based at least in part on the operational data. A graphical representation may be generated for each active route composite among the set of one or more active route composites. The graphical representation may include an aircraft identifier of a corresponding autonomous aircraft among the set of one or more remotely supervised autonomous aircraft and a representation of an active route associated with the corresponding autonomous aircraft. The graphical representations for the set of one or more active route composites may be displayed on a display device. Each graphical representation may be updated periodically or in real time to indicate a current progression of the corresponding autonomous aircraft along the representation of the active route, where the graphical representations are visually uniform.

In yet another aspect, one or more non-transitory, machine-readable media may have machine-readable instructions thereon which, when executed by one or more processing devices, cause a system to perform one or a combination of the following operations. Operational data corresponding to a set of one or more remotely supervised autonomous aircraft may be received. A set of one or more active route composites may be generated based at least in part on the operational data. A graphical representation may be generated for each active route composite among the set of one or more active route composites. The graphical representation may include an aircraft identifier of a corresponding autonomous aircraft among the set of one or more remotely supervised autonomous aircraft and a representation of an active route associated with the corresponding autonomous aircraft. The graphical representations for the set of one or more active route composites may be displayed on a display device. Each graphical representation may be updated periodically or in real time to indicate a current progression of the corresponding autonomous aircraft along the representation of the active route, where the graphical representations are visually uniform.

In various embodiments, the graphical representation of the active route may include a flight path represented with a predetermined length within a mission tile. In various embodiments, each mission tile may display an aircraft progression indicator that indicates a progression of a corresponding autonomous aircraft of the set of one or more remotely supervised autonomous aircraft along the representation of the active route. In various embodiments, the aircraft progression indicator may be caused to move along the representation of the active route according to a flight path scale that represents a relationship between a distance along the flight path represented with the predetermined length and a corresponding distance along the flight path that the corresponding autonomous aircraft is to travel for a corresponding mission. In various embodiments, each mission tile may be user-selectable to reveal contextual data about a mission corresponding to the mission tile and a corresponding aircraft of the set of one or more remotely supervised autonomous aircraft.

In various embodiments, one or more spatial limits with interface elements may be caused to appear positioned along the representation of the flight path, wherein the spatial limits correspond to limits along the flight path requiring attention of a ground supervisor. In various embodiments, one or more attentional aids with interface elements may be caused to appear in each mission tile when a particular time is approaching for an action to be taken in the corresponding mission. In various embodiments, one or more attentional aids with interface elements may be caused to appear in each mission tile based on mission-specific conditions. In various embodiments, one or more timers may be generated for critical events for each mission. The one or more timers may be activated based on spatial triggers and/or temporal triggers, and the one or more timers may trigger visual and/or audible alerts when approaching deadlines. In various embodiments, one or more memory aids with interface elements may be caused to appear in each mission tile. The one or more memory aids may visually represent completed tasks and/or pending tasks associated with each mission. In various embodiments, each graphical representation may include a uniform background and a line representing the active route. In various embodiments, a dimension of the line may be proportionate to a spatial or temporal length of the active route.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an overview of a voice communications system for voice communications between a ground supervisor and air traffic control (ATC), in accordance with certain embodiments according to the present disclosure.

FIG. 1B illustrates a block diagram of an exemplary system architecture for providing and facilitating multiple missions progression monitoring user interface (“MMPM UI”), in accordance with various embodiments according to the present disclosure.

FIG. 2 illustrates an example area of operations, in accordance with embodiments according to the present disclosure.

FIG. 3A illustrates at least part of an example of a MMPM UI for 1:n automated vehicles operations, in accordance with embodiments according to the present disclosure.

FIG. 3B illustrates a close-up of at least part of an example MMPM UI for 1:n automated vehicles operations, in accordance with embodiments according to the present disclosure.

FIG. 4 illustrates at least part of an example MMPM UI representing active route composites, in accordance with embodiments according to the present disclosure.

FIG. 5 illustrates a close-up at least part of an example active route composite, in accordance with embodiments according to the present disclosure.

FIG. 6 illustrates at least part of an example MMPM UI with active routes displayed with a horizontal orientation, in accordance with embodiments according to the present disclosure.

FIG. 7 illustrates one example method for facilitating supervision of operations of remotely supervised autonomous aircraft, in accordance with embodiments according to the present disclosure.

FIG. 8 illustrates aspects of a computer system that may be incorporated as part of the part of a multiple missions progression monitoring system, a multi-vehicle supervision system, a ground control station, and/or other components that facilitate the MMPM UI, in accordance with embodiments of this disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

Disclosed embodiments may provide for a multiple missions progression monitoring (“MMPM”) system that may be configured as an integrated software and/or hardware platform to provide a multiple missions progression monitoring user interface (“MMPM UI”). The MMPM system may be deployed within a ground control station (GCS), a multi-vehicle supervision system (MVSS), or as a standalone module operatively coupled to supervisory workstations. The MMPM system may be designed to aggregate operational data from a plurality of remotely supervised autonomous vehicles, drawing from sources such as flight management systems, onboard sensors, communications infrastructure, and air traffic control interfaces. The MMPM system may leverage real-time data feeds and may employ a modular architecture that enables dynamic scaling to support supervision of any number of missions concurrently. The MMPM system may be implemented using one or more processing devices, memory, communications subsystems, and display devices, as described in further detail herein, and may be configured to generate, update, and display active route composites, timers, attentional aids, memory aids, and monitoring aids as part of the MMPM UI. The MMPM UI may support the supervision of multiple autonomous vehicles in operation with one supervisor to many remotely supervised autonomous vehicles.

Disclosed embodiments may address technical challenges associated with maintaining robust situational awareness across a fleet of high-automation vehicles by presenting mission-critical information in a consolidated and prioritized manner, thereby reducing cognitive load and the risk of information overload. Among other features, disclosed embodiments may provide dynamic mission progression visualization, real-time vehicle status aggregation, automated anomaly detection, and prioritized alert management. These features may enable the operator (i.e., a ground supervisor) to rapidly assess mission states, identify and resolve exceptions, and efficiently allocate attention among concurrent missions. Additionally, disclosed embodiments may employ adaptive interface elements that tailor information density and content based on mission complexity and operator context, providing a scalable solution for both small and large autonomous fleets. By implementing these technical advancements, disclosed embodiments may facilitate improved decision-making, decreased operator workload, increased operational efficiency, and a reduction in the likelihood of supervisory errors during multi-vehicle operations.

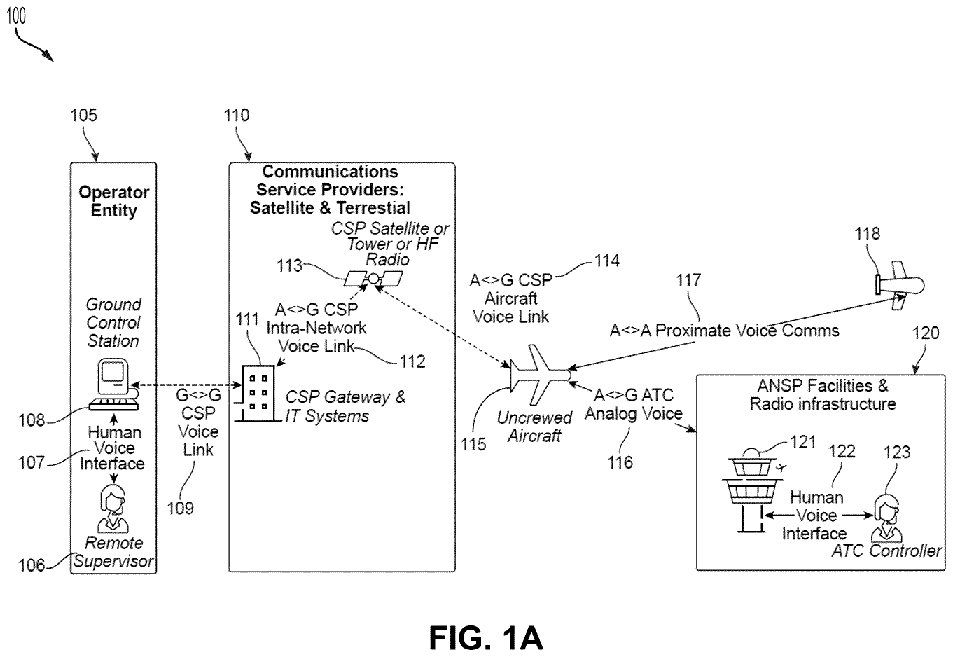

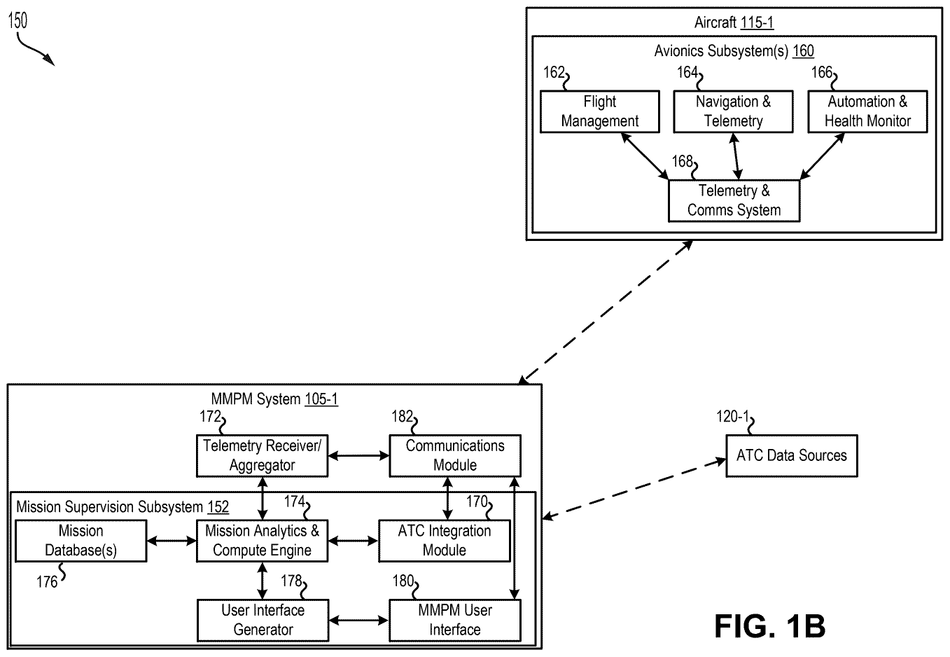

Various embodiments will now be discussed in greater detail with reference to the accompanying figures, beginning with FIG. 1A.

FIG. 1A illustrates an overview of a voice communications system 100 for voice communications between a ground supervisor and an air traffic control (ATC), in accordance with certain embodiments according to the present disclosure. The voice communications system 100 may include one or more remotely supervised autonomous aircraft system operator entity systems 105 (operator entity system 105, which also may be referenced herein as the multi-vehicle supervision system (MVSS)), one or more communications service providers (CSPs) 110, one or more remotely supervised autonomous aircraft 115 (aircraft 115), and air navigation service provider (ANSP) facilities and radio infrastructure 120. In the example operator entity system 105 depicted, the operator entity system 105 may include a ground supervisor 106 and a ground control station (GCS) 108. The operator entity system 105 may include a remote supervisor segment (RSS) that is configured to function as a high-level, “human-on-the-loop” software architecture within the operator entity system 105. The RSS may be distinct from the GCS 108's physical data link management. The RSS may be configured to aggregate telemetry from multiple aircraft 115 and facilitate a unified interface for the ground supervisor 106, acting as a supervisory arbitration layer to prioritize voice communications.

In the example communications service provider (CSP) 110 depicted, the CSP 110 may include terrestrial and satellite components. Such components may include terrestrial communications infrastructure 111, such as CSP gateway and information (IT) systems. Such components may also include air-ground (A<>G) communications infrastructure 113, such as a CSP satellite, tower, and/or high frequency (HF) radio. The ANSP facilities and radio infrastructure 120 may include an ATC system 121 and an ATC controller 123.

In general, aircraft voice relay may work in the following manner for the case in which the direction is from the ground supervisor 106 to the ATC controller 123. A human voice interface 107 may communicatively couple the ground supervisor 106 with the GCS 108. Voice from speech of the ground supervisor 106 may be converted from an analog format to a digital format via encoding, e.g., with the human voice interface 107 at a ground supervisor workstation within the GCS 108.

The digitally encoded voice may be sent to the aircraft 115 from the GCS 108 over one or more communications links to the aircraft 115. The CSP 110 may be used to link the GCS 108 and the aircraft 115. A ground-to-ground (G<>G) CSP voice link 109 may communicatively couple the GCS 108 with the terrestrial communications infrastructure 111. An A<>G CSP intra-network voice link 112 may communicatively couple the terrestrial communications infrastructure 111 with the A<>G communications infrastructure 113. An A<>G CSP aircraft voice link 114 may communicatively couple the A<>G communications infrastructure 113 with the aircraft 115.

At the aircraft 115, the digitally encoded voice may be converted to an analog format. The ground supervisor's voice may then be transmitted by the aircraft's VHF radio. An A<>G ATC analog voice link 116 may communicatively couple the aircraft 115 with the ATC system 121. One or more ground receivers of the ANSP facilities and radio infrastructure 120 may receive the analog VHF radio frequency (RF) signals. A human voice interface 122 may communicatively couple the ATC system 121 with the ATC controller 123. The ATC system 121 may use the human voice interface 122 to process the analog voice signals and provide analog audio into a listening device of the ATC controller 123, such as a headset. The process of providing voice communications from the ATC controller 123 to the ground supervisor 106 may work in the opposite direction as described above.

Disclosed embodiments may not only be applicable to satellite communications links to aircrafts but also to other link types. Communications links between an operator's GCS 108 and aircraft 115 may be physically implemented in a number of different ways: a simple point-to-point RF link, or via a CSP 110 that has a network of transmitters and receivers, such as a satellite provider, or a terrestrial network such as a cellular mobile network operator. For example, the A<>G CSP intra-network voice link 112 may correspond to an HF radio transporting voice in any propagation path. In that example, the A<>G link between the HF transceiver of the A<>G communications infrastructure 113 and the aircraft 115 may utilize the same HF frequency for all aircraft operating in the same VHF frequency.

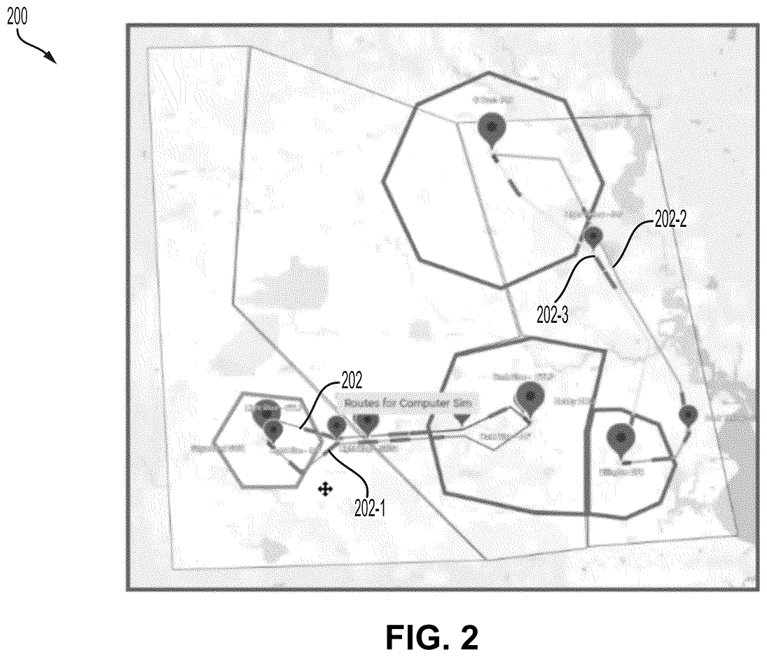

FIG. 2 illustrates an example area of operations 200, in accordance with embodiments according to the present disclosure. The example area of operations 200 depicts the location of vertiports, routes, airport control zones, air traffic controller sectors, etc. where missions may be flown. Disclosed embodiments may address the problem of multi-mission operator control. This may include addressing a significant human factors challenge arising from the increasing prevalence of automated aircraft operations. Specifically, disclosed embodiments may target the difficulties experienced by operators managing multiple aircraft simultaneously, a scenario becoming increasingly common in commercial and civil aviation due to advancements in autonomous flight control systems. Traditional flight operations, while complex, typically involve a relatively linear sequence of actions-taxi, climb, cruise, descend, and land-performed sequentially for each aircraft. However, with the rise of automated systems, operators are now tasked with overseeing numerous aircraft concurrently, each executing its own mission along potentially overlapping routes. For example, illustrated are multiple routes 202 (e.g., 202, 202-1, 202-2, 202-3) that may go from airport to airport and then in the opposite direction, for example. One remote supervisor may manage each of the routes 202 at the same time.

Current operational paradigms struggle to effectively manage this complexity. The inherent sequential nature of traditional flight phases may be disrupted when multiple aircraft are simultaneously engaged in various operational phases. For example, one aircraft may be in a take-off sequence while another is in a cruise phase, and a third is descending. This may create a fragmented operational picture, demanding that the operator maintain a constantly updated mental representation of the state of each aircraft-its current phase, its intended trajectory, and any required actions. This may be further complicated by the fact that these aircraft may be operating along different routes, each with its own timeline. The operator must then prioritize actions across these multiple timelines, anticipating potential conflicts and coordinating responses in a timely manner. The cognitive load associated with this task may be substantial, increasing the risk of operator error and potentially compromising operational safety. Existing systems lack the ability to effectively synthesize this multi-faceted operational information and present it to the operator in a manner that facilitates rapid and informed decision-making.

While autopilots and automated flight control systems exist, current implementations do not adequately address the operator's need for a consolidated, real-time understanding of the state of multiple aircraft operating concurrently. Existing systems often provide isolated data streams, failing to integrate this information into a coherent operational picture. Furthermore, current systems lack the functionality to prioritize tasks across multiple timelines, presenting a significant barrier to efficient and safe multi-mission operation.

Embodiments disclosed herein address such problems. The MMPM system may be configured to provide the MMPM UI to mitigate the challenges described above. Referring again to FIG. 1A, in various embodiments, the MMPM system may be included in or otherwise facilitated by the MVSS (operator entity system 105)—for example, in some embodiments, by the GCS 108—which may aggregate telemetry and other operational data from each aircraft 115 under supervision. In various embodiments, the MMPM UI may be facilitated by the operator entity system 105 and its associated components (e.g., in or otherwise facilitated by the GCS 108 and/or integrated into an MVSS interface). In some embodiments, the MMPM UI may be used in combination with a map or terrain view, where the progression monitoring UI supports temporal and task management and the map view provides spatial situational awareness, such as terrain, obstacles, or weather information.

To further illustrate the functional architecture for generating and presenting multiple missions progression monitoring features, FIG. 1B illustrates a block diagram of an exemplary system architecture 150 for providing and facilitating a MMPM UI 180, in accordance with various embodiments according to the present disclosure. The system architecture 150 may be suitable for use with aircraft, ground-based MMPM systems 105-1, and communications infrastructure as described above. The system architecture 150 may be implemented in a wide variety of aircraft and ground-based supervisory environments and may be particularly suitable for supporting autonomous or remotely supervised multi-vehicle operations. As depicted, system architecture 150 may include both onboard components (e.g., within an aircraft 115-1) and ground-based supervisory components (e.g., within an MMPM system 105-1), each comprising multiple modular components. The components of system 150 may be communicatively interconnected via one or more data links, which may include wireless, satellite, or terrestrial communication pathways. Components may be implemented in hardware, software, or a combination thereof, and may be distributed or centralized as appropriate for a given use case. The example of architecture 150 illustrates integration of telemetry data from supervised aircraft (e.g., 115-1), operational data from onboard and ground-based modules, and ATC data sources 120-1 within the ground-based MMPM system 105-1. The architecture 150 illustrates may enable real-time, context-aware mission monitoring and supervisory control in complex, multi-vehicle operational environments.

The onboard portion of system architecture 150 may include an avionics subsystem 160 that includes several integrated modules. A flight management system 162 may be configured to store and process data describing aircraft state parameters, operational schedules, mission configuration, and onboard sensor inputs. A navigation and telemetry module 164 may determine the aircraft's position, heading, velocity, mission phase, and other relevant flight parameters, for example using GPS, inertial measurement units, and barometric sensors. An automation and health monitoring module 166 may be configured to assess system status, automation level, and detect anomalies or off-nominal conditions that may require operator intervention. The avionics subsystem 160 may be communicatively coupled to a telemetry and communications system 168, which may aggregate relevant data from the flight management system 162 and navigation module 164—including current progression status, spatial and temporal triggers, task reminders, system health, and mission-specific events—and transmits this data to the ground-based MMPM system 105-1 via one or more data links. The telemetry and communications module 168 may also receive uplinked supervisory instructions, configuration updates, or feedback from the MMPM system 105-1, supporting secure, authenticated, and fault-tolerant bidirectional data transmission.

On the ground, the MMPM system 105-1 may include a mission supervision subsystem 152 that includes one or a combination of a mission analytics and computation engine 174, a user interface generator 178, one or more mission database(s) 176, and/or the MMPM UI 180. These components may collectively provide advanced mission monitoring features, including real-time mission progression visualization, task prioritization, context-sensitive alerts, and integration with operational, vehicle, and ATC data sources 120-1. The mission supervision subsystem 152 may be configured to receive and process telemetry, mission status, and event data, generate actionable decision support regarding mission progression, and present this information to a ground supervisor via the integrated interface, MMPM UI 180. By grouping these modules as the mission supervision subsystem 152, the architecture highlights their functional integration as a modular subsystem responsible for distilling complex multi-mission data into clear, actionable supervisory guidance. In some embodiments, the mission supervision subsystem 152 may be implemented as a logically or physically integrated subsystem, or its constituent components may be distributed across multiple hardware or software platforms within the MMPM system 105-1.

The MMPM system 105-1 may include a telemetry receiver and aggregator 172 configured to receive, process, and store telemetry and status data from one or more supervised aircraft. The MMPM system 105-1 may further include an ATC integration module 170 configured to receive, parse, and process data from one or more ATC data sources 120-1, such as digital ATC communications links, operator-entered ATC instructions, or integrated airspace management systems. The ATC integration module 170 may be communicatively coupled to the mission analytics and computation engine 174 and may provide real-time ATC clearances, traffic advisories, or airspace restrictions as actionable inputs to the supervisory workflow. The telemetry receiver and aggregator 172 may be communicatively coupled to the mission analytics and computation engine 174. The engine 174 may process operational, telemetry, ATC, and contextual data—including mission timelines, aircraft progression, spatial and temporal triggers, automation status, and energy usage patterns—to generate up-to-date mission monitoring information for each supervised aircraft. This may include, for example, identifying which missions require immediate attention, detecting anomalies or deviations from planned mission profiles, computing task prioritization, and synthesizing alerts. For instance, if an ATC clearance imposes a new altitude restriction on a particular aircraft, the engine 174 may update the corresponding mission progression indicator and generate an alert to the supervisor. If an ATC traffic advisory indicates potential conflict, the engine 174 may reprioritize operator attention or recommend specific actions. In some embodiments, the engine 174 may also integrate ATC instructions, operational rules, or supervisor preferences in generating decision support output. One or more processing devices may analyze the current progression of each supervised aircraft in relation to mission-specific triggers and conditions. For example, if the aircraft 115-1 is projected to reach a critical spatial or temporal threshold within a predefined window, the engine 174 may generate an attentional aid or alert to focus operator attention. The engine 174 may utilize algorithms for predictive assessment, task scheduling, and anomaly detection, which may be implemented within the engine 174 or onboard subsystems and may be configured to process both aircraft-specific telemetry, ATC data, and operational data to assess supervisory needs.

The user interface generator 178 may be configured to create interactive, context-sensitive displays for presentation of the mission monitoring information in the MMPM UI 180, accessible to one or more ground supervisors as a graphical user interface. The MMPM UI 180 may render actionable mission progression indicators, task reminders, attentional aids, memory aids, and monitoring aids in a manner that supports rapid operator understanding and decision-making. The MMPM UI 180 may display per-aircraft mission status, including visually uniform route representations, progression indicators, countdown timers, spatial and temporal triggers, color-coded alerts, and supporting information such as automation status or system health notifications. In some embodiments, the user interface generator 178 may also provide means for inputting supervisory commands or annotations, which may be relayed to the aircraft 115-1 via a communications module 182. The communications module 182 may handle bidirectional exchange of data and commands between the MMPM system 105-1 and each supervised aircraft 115, utilizing available communications infrastructure (e.g., satellite, cellular, dedicated RF links), for example, via the CSP illustrated in FIG. 1A.

In operation, the system architecture 150 may enable continuous aggregation and processing of aircraft state, mission status, and operational data, permitting real-time or near-real-time generation and display of actionable mission progression monitoring features. The architecture 150 may support cooperative operation between onboard automation and ground-based supervision, allowing for efficient human-machine teaming and robust operational assurance even in multi-vehicle scenarios. While FIG. 1B depicts one exemplary arrangement of components, it should be understood that the specific implementation and interconnection of modules may vary according to aircraft type, operational context, and communications infrastructure. The block diagram is intended to illustrate one possible instantiation of the system and is not limiting. Additional modules, such as data logging, redundancy management, machine learning analytics, or advanced human-machine interface elements, may be included within the scope of disclosed embodiments. Components illustrated in FIG. 1B may be omitted, combined, or further subdivided in various embodiments. The block diagram is intended to illustrate one possible instantiation of the system and is not limiting.

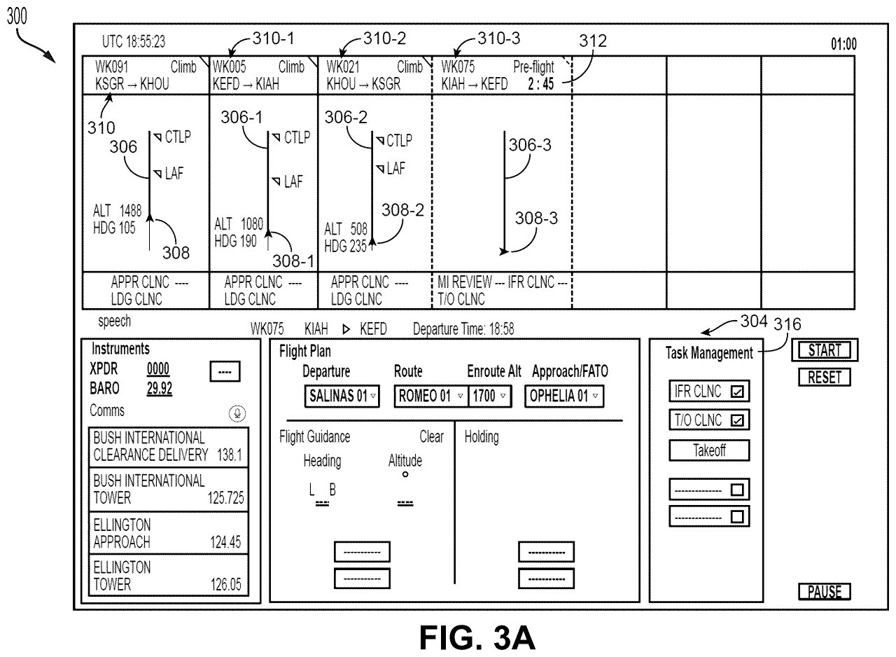

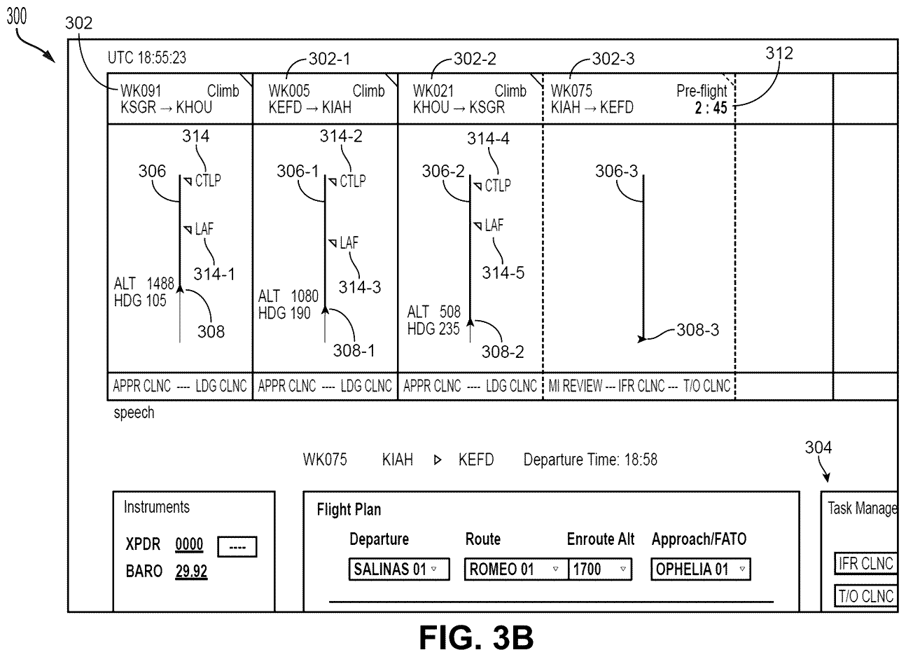

FIGS. 3A and 3B illustrate at least part of an example multiple missions progression monitoring user interface for 1:n automated vehicles operations (“MMPM UI”) 300, in accordance with embodiments according to the present disclosure. FIG. 3B is a close-up of part of the MMPM UI 300. The MMPM UI 300 may be an example of the MMPM UI 180 of FIG. 1B. The MMPM system 105-1 may include, provide, and/or otherwise facilitate the MMPM UI 300. The MMPM system 105-1 may receive operational data indicative of a set of one or more statuses and set of one or more locations corresponding to a set of one or more remotely supervised autonomous aircraft. Based at least in part on the operational data, the MMPM system 105-1 may generate and continuously update the following features of the MMPM UI 300.

Based at least in part on the operational data, the MMPM system 105-1 may generate and continuously update an active route composite 310. The MMPM UI 300 may be scalable to include several active route composites 310 (i.e., 310, 310-1, 310-2, 310-3, etc.), each corresponding to an active route and mission. The MMPM UI 300 may be designed to support supervision of a large number of simultaneous missions, for example, up to ten or more, with adaptive management of display elements to ensure continued operator effectiveness and minimize cognitive overload. The active route composites 310 may correspond to graphical representations that are visually uniform. Each graphical representation may include a uniform background and a line representing the corresponding active route 306. In some embodiments, a dimension of the line may be proportionate to a spatial or temporal length of the active route 306.

Each active route composite 310 may be represented with a mission tile particularized to a particular mission and displayed in the MMPM UI 300. Each mission tile may be user-selectable to reveal contextual data about the selected mission. The contextual data may be exposed, for example, in a lower portion of the MMPM UI 300, as in the example illustrated in FIG. 3A. Selecting a mission tile may cause task lists, flight plans, and other mission-specific controls or data to be contextually updated for the selected flight, while global attentional or monitoring aids for other missions may continue to be displayed as required.

The MMPM UI 300 may provide for dynamic scalability, wherein the number of mission tiles and route composites displayed may be adjusted based on operator workload, system configuration, or operational requirements. The MMPM system 105-1 may allow for operator customization of the UI layout, including horizontal or vertical alignment of mission tiles, selective display of memory and monitoring aids, and adjustable thresholds for attentional aids and alerts. Operator interaction with the MMPM UI 300 may be facilitated through multiple modalities, such as mouse, touchscreen, voice commands, or keyboard input, with event-driven feedback to maintain a seamless supervisory workflow. The MMPM system 105-1 may further support integration with external decision-support modules, such as automated prioritization algorithms, predictive analytics for energy consumption, and risk assessment engines, which may be invoked in response to mission-specific conditions or operator requests.

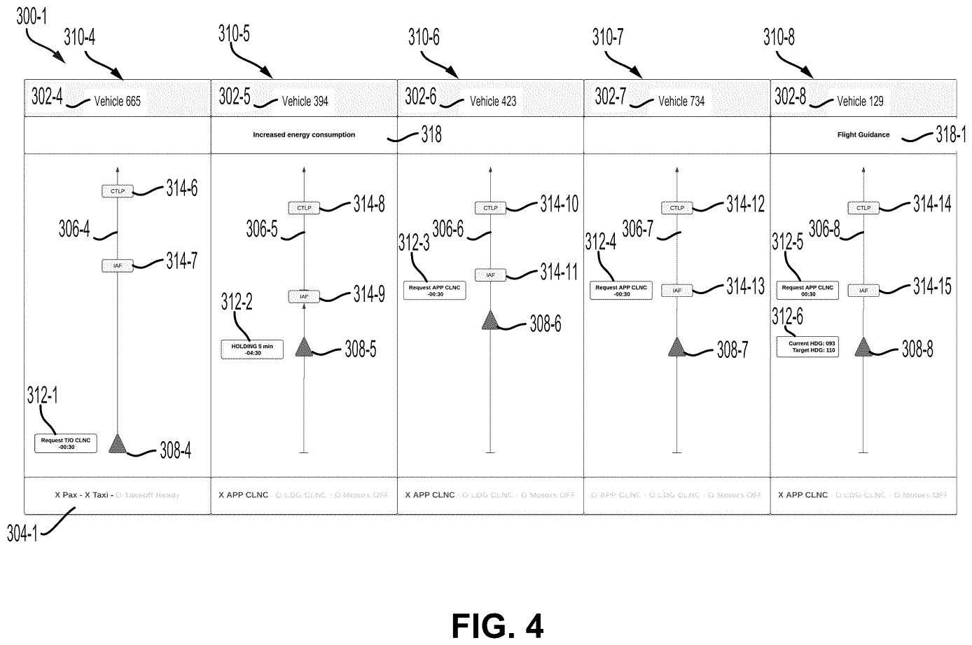

The depicted example illustrates four active route composites 310 and, hence, four active routes. More or fewer active routes may be represented in various implementations. For example, FIG. 4 illustrates at least part of an example MMPM UI 300-1 representing five active route composites 310 (i.e., 310-4, 310-5, 310-6, 310-7, 310-8) and, hence, five active routes, in accordance with embodiments according to the present disclosure.

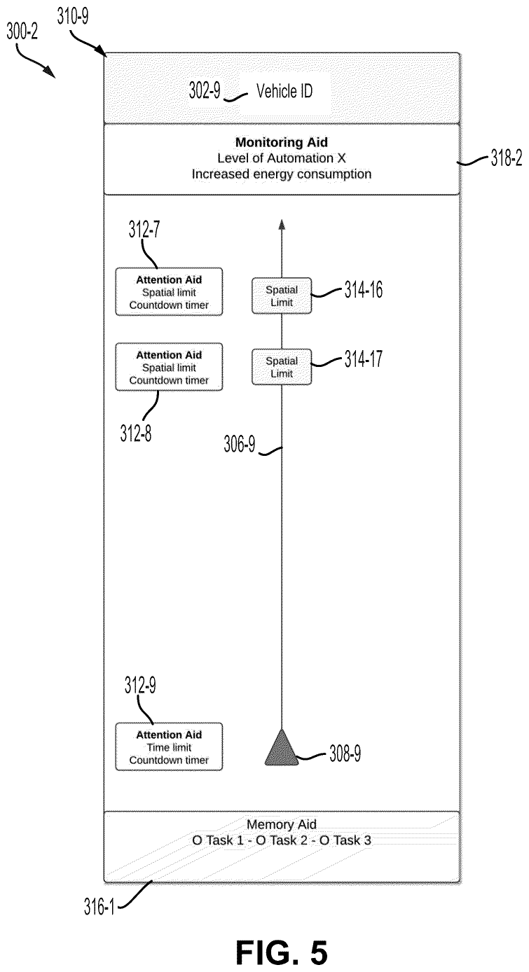

FIG. 5 illustrates a close-up at least part of an example active route composite 310-9 for the MMPM UI 300-2, in accordance with embodiments according to the present disclosure. The active route composites 310 (including 310-9) may include sets of functions that may be represented using a combination of visual and/or aural elements. The active route composites 310 may also include a specific visual presentation of visuo-spatial elements that may allow an easier, faster, and more accurate visual search and visual scanning compared to a map. The elements of the active route composites 310 may be specifically engineered to allow an operator to continuously perform a situation assessment with an optimal level of workload, minimizing time-on-task, and errors. The MMPM UI 300 may allow the operator to quickly and easily gain knowledge about the status of each mission and consequently to understand which missions and which aspects of the missions require the operator's attention in their near future (e.g., in approximately the next one to two minutes, or more in some embodiments).

The MMPM UI 300 may provide a streamlined visual representation of active routes, coupled with dynamic alerts and memory aids, to optimize operator workload, enhance situational awareness across multiple missions, facilitate temporal management, and facilitate task prioritization. The MMPM UI 300 may graphically indicate information that is functionally related (e.g., all information functioning as memory aid) will be horizontally or vertically aligned as long as it will not be interspersed with irrelevant information (i.e., pertaining to a different functional category). This may enable the operator to rapidly compare the same type of information for each mission without the need for inhibiting irrelevant information (selective attention). In various embodiments, cognitive aids and other elements of the MMPM UI 300 may be always visible or may appear when specific conditions become true (e.g., to reduce visual clutter). For example, in some embodiments, attentional aids may be hidden or suppressed unless an action is required and may automatically disappear or deactivate once the user has marked a corresponding task as complete. The MMPM system 105-1 may include logic to avoid presenting redundant or unnecessary alerts, thereby minimizing operator distraction and workload.

The MMPM UI 300 may be configured to provide for aircraft identification 302, which may be included in the active route composites 310. For example with respect to FIGS. 3B and 4, the interface may display the callsign and/or other identifier (ID) 302 (i.e., 302, 302-1, 302-2, . . . 302-9, etc.) of each aircraft under the operator's supervision. This may facilitate rapid identification and may allow for targeted interactions with individual aircraft. The MMPM system 105-1 may be configured to provide multiple opportunities for encoding and recalling callsigns.

The MMPM UI 300 may be configured to provide for simplified representation of active routes 306 (e.g., 306, 306-1, 306-2, 306-3, . . . 306-9, etc.) with graphical representations that are visually uniform. Each active route 306 may be represented separately as a straight line on the visual display and may be identified by the vehicle callsign/ID 302. The representation of the active route 306 may include a flight path represented with a predetermined length within the mission tile. The association of each route 306 with a vehicle callsign/ID 302 may allow for rapid identification.

The representation of the active routes 306 may simplify spatial understanding and reduce the cognitive load associated with complex flight paths. In the illustrated examples, the active routes 306 are depicted with a vertical orientation. In some embodiments, the active routes 306 may be depicted with a horizontal orientation. In various embodiments, the MMPM system 105-1 and the MMPM UI 300 may permit the user to select between vertical and horizontal visual orientations of the route representations an interface control enabling the operator to select between vertical or horizontal display modes, or may provide only one orientation depending on system configuration or operational requirements. In some embodiments, the horizontal orientation may include altitude profile information, while the vertical orientation may show a simplified path without altitude changes.

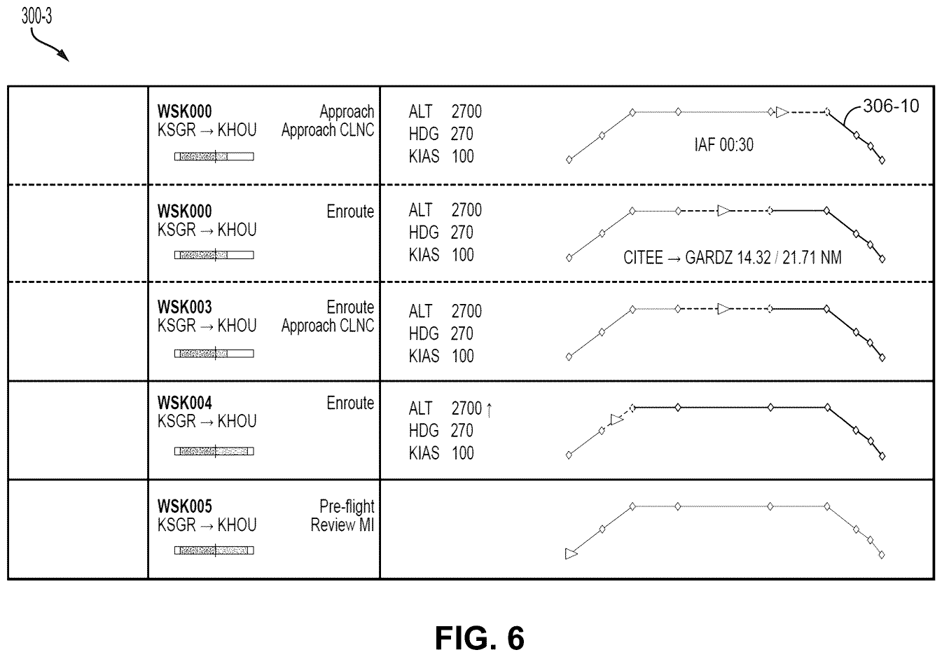

By way of example, FIG. 6 illustrates at least part of an example MMPM UI 300-3 with active routes 306-10 displayed with a horizontal orientation, in accordance with embodiments according to the present disclosure. All features disclosed herein with respect to the vertical orientation of the active routes 306 may likewise be applied to the horizontal orientation illustrated in FIG. 6. However, the illustrated horizontally represented active routes 306-10 may additionally depict the altitude profile of the aircraft and flight path according to scale with changing heights of the active routes 306-10, whereas the vertically represented active routes 306 may be represented with a straight line.

Referring again to FIGS. 3A-5, the MMPM system 105-1 may track the progression of each aircraft and expose progression status via the MMPM UI 300. The MMPM UI 300 may be updated periodically or in real time to indicate a current progression of the corresponding autonomous aircraft along the representation of the corresponding active route 306. An aircraft progression indicator 308 (e.g., 308, 308-1, 308-2, . . . 308-9, etc.) for each aircraft may be represented relative to the spatial limits 314 (e.g., 314, 314-1, 314-2, . . . 314-16, 314-17, etc.) requiring the operator's attention. Thus, an aircraft progression indicator 308 may move along its respective route 306 according to scale, in order to accurately represent the progress of the aircraft (e.g., as a percentage of the flight path completed). Stated otherwise, the aircraft progression indicator 308 may be caused to move along the representation of the active route according to a flight path scale that represents a relationship between a distance along the flight path represented with a predetermined length in the mission tile and a corresponding distance along the flight path that the corresponding aircraft is to travel for the corresponding mission. Thus, each mission, flight path, and mission tile may have its own distinct flight path scale that maps the distances represented in the mission tile to the actual distances traveled (and/or to be traveled) by the corresponding aircraft.

Likewise, the spatial limits 314 may appear with interface elements positioned along the respective route 306 according to scale, in order to accurately map the spatial limits 314 to points along the flight path. The spatial limits 314 may include user-selectable interface elements that may be selected to expose more details about the spatial limits 314 (e.g., with pop-ups, drop-downs, frames, and/or another part of the MMPM UI 300, such as the lower portion of the MMPM UI 300 in FIG. 3A).

In various embodiments, the length of each line of each active route 306 may reflect the actual length of each route or all may be depicted with the same predetermined length. In some embodiments, the dimension (e.g., length) of the line representing each active route 306 may be proportional to either the actual spatial distance or the expected temporal duration of the corresponding route, thereby allowing for a more intuitive comparison between missions of varying lengths. The aircraft progression indicator 308 for each aircraft may represent progression of the vehicle as it moves along the line according to its ground speed and its progression along its actual flight path. In terms of spatial limits 314, the MMPM UI 300 may improve the overall system performance by reducing the task demands required for visually finding the vehicles locations as well as the spatial limits 314 of interest (e.g., the initial approach fixes) and for comparing the distance of each vehicle from the next spatial limit 314 of interest across multiple missions.

Before takeoff or after landing of a particular flight, the MMPM UI 300 may be configured to provide for ground operations progression indicia 304. For example, ground operations progression indicia 304 may indicate the status of pre-flight tasks for each mission, including takeoff time and current time, which the MMPM system 105-1 may collect from any suitable data source. This information may be crucial for determining when an aircraft is ready for takeoff.

The MMPM UI 300 may provide for attentional aids 312 (e.g., 312, 312-1, 312-2, . . . 312-7, 312-8, 312-9, etc.) as the aircraft and its aircraft progression indicator 308 advances along its route 306 and reaches or approaches various spatial or temporal trigger points. The attentional aids 312 may correspond to dynamically displayed alerts about upcoming action points along the flight path. In some embodiments, the attentional aids 312 may also include readiness prompts or warnings that encourage the operator to focus attention or prepare for immediate action at critical junctures, such as final approach points or windows for required communications. The attentional aids 312 may capture the operator's attention towards missions requiring immediate action or action soon (i.e., within an upcoming time window). Examples may include alerts triggered when a particular time is approaching for an action to be taken in a particular mission, when an aircraft deviates from its planned route, when an aircraft need flight guidance, when an aircraft missed an approach because a final approach and take-off area is unavailable, when an aircraft needs to perform a detect and avoid maneuver due to traffic, and/or the like. In various embodiments, the MMPM system 105-1 may be configured such that attentional aids 312 may be triggered and displayed in each mission tile based not only on temporal thresholds but also on mission-specific conditions, such as the detection of off-nominal events, changes in automation level, or any other user-defined criteria relevant to the operational context. For example, attentional aids 312 may appear when the MMPM system 105-1 detects that an aircraft has entered a reduced automation mode, when increased energy consumption is observed, or when specific operational anomalies are flagged by the system or by operator input. In some embodiments, the criteria for triggering attentional aids 312 may be configurable by the user or by supervisory policy, enabling flexible adaptation to various mission profiles and operational requirements.

The attentional aids 312 may include user-selectable interface elements that may be selected to expose more details about the alerts (e.g., with pop-ups, drop-downs, frames, and/or another part of the MMPM UI 300, such as the lower portion of the MMPM UI 300 in FIG. 3A) and to take operator actions with respect to tasks mapped to the attentional aids 312 (e.g., communicating with the aircraft, causing the aircraft to perform one or more operations such as climb to a certain altitude or maintain a certain altitude, communicating with the ATC and obtaining clearances, controlling the aircraft, marking the tasks as complete, and/or the like). Attentional aids may further include auditory signals or alerts to supplement visual cues, thereby enhancing operator awareness of urgent or time-critical events. The attentional aids 312 may include countdown timers, which the MMPM UI 300 may be configured to provide. Before each flight and as the aircraft and its aircraft progression indicator 308 advances along its route 306, the MMPM system 105-1 may perform time estimations for each aircraft and when associated tasks for each aircraft needed to be completed. As the aircraft and its respective aircraft progression indicator 308 advances along its route 306, the MMPM system 105-1 may expose the time estimations along with indicia of the associated tasks via the dynamically displayed attentional aids 312. In some embodiments, the attentional aids 312 may graphically change in an escalating manner (e.g., change colors, increase sizes, flash, augment the graphics with additional graphics, and/or the like) as the countdown timers approach zero in order to escalate visibility of the attentional aids 312 and attract attention of the operator of the impending deadline to complete corresponding tasks. If the operator has already completed or acknowledged a particular task, the corresponding attentional aid may be suppressed or removed to avoid unnecessary distraction.

Each active route composite 310 may be associated with a count-down timer. As the aircraft and its aircraft progression indicator 308 advances along its route 306, the timers and associated tasks included in attentional aids 312 may be dynamically updated and triggered to appear with the attentional aids 312 on the MMPM UI 300 (e.g., via popups or any other suitable visual element, along with any suitable audible alerts) based on real-time operational data and are designed to alert the operator to impending temporal limits and corresponding tasks (which may be a function of the aircraft and its aircraft progression indicator 308 reaching or approaching various spatial or temporal trigger points along its route 306).

The timers and associated tasks of the attentional aids 312 may be triggered by the position of the aircraft on the Earth (spatial trigger) and/or by temporal triggers (e.g., with reference to departure time, arrival time, flight time, and/or the like). The MMPM UI 300 may include visually distinct indicators for spatial and temporal triggers, such as different shapes, colors, or iconography, to assist the operator in quickly discerning the nature of upcoming tasks or alerts. In some examples, once the aircraft reaches a certain spatial point or once the flight time has reached a certain temporal point, interaction with an air traffic controller may be required in 10 seconds, 2 minutes, etc. The count-down timers and associated tasks of the attentional aids 312 may remove from the operator some computational burden and their appearance may act as attentional aids. Specifically, count-down timers and associated tasks of the attentional aids 312 may aim at 1) reducing operator's workload generated by making time judgments about how much time is left before a vehicle reaches a spatial or a time limit and therefore 2) reducing time-on-task, 3) reducing errors by increasing the accuracy of time estimations (human are bad at estimating time), and 4) off-loading the working memory from maintaining active and updating all the time estimations as well as comparing them to each other in order to prioritize a mission over others.

The MMPM UI 300 may provide for memory aids 316 (including 316-1 illustrated, for example, with respect to FIG. 5) as upcoming tasks need to be performed and as the tasks are completed. These may visually represent completed or pending tasks associated with each mission (e.g., mission intent review, ATC clearances). The memory aids 316 may allow the operator to remember by visually perceiving what predictable tasks have been marked as completed for each mission. Such tasks may include, by way of example, requesting and receiving ATC clearances, performing preflight and inflight communications, monitoring and managing energy reserves, responding to off-nominal events such as route diversions, and confirming completion of mission-specific actions. This may reduce operator workload by minimizing the need to maintain detailed information in working memory, may prevent repetition of tasks, and may prevent forgetting to perform tasks. The memory aids 316 may include user-selectable interface elements that may be selected to expose more details about the alerts (e.g., with pop-ups, drop-downs, frames, and/or another part of the MMPM UI 300, such as the lower portion of the MMPM UI 300 in FIG. 3A) and to take operator actions with respect to tasks mapped to the memory aids 316 (e.g., communicating with the aircraft, causing the aircraft to perform one or more operations, communicating with the ATC, controlling the aircraft, marking the tasks as complete, and/or the like).

As the aircraft and its aircraft progression indicator 308 advances along its route 306 and experiences off-nominal conditions (e.g., aircraft has been vectored) that require operator monitoring but not immediate action, the MMPM UI 300 may provide for monitoring aids 318 (illustrated, for example, with respect to FIGS. 4 and 5). In some embodiments, monitoring aids 318 may further be activated in response to specific special statuses, such as diversions to alternate destinations, unexpected energy usage patterns, or reduced automation levels, and may present the user with tailored data or decision support relevant to those conditions. The monitoring aids 318 may indicate to the operator which vehicle is in a state (e.g., an abnormal/off-nominal condition) that may require the operator's intervention should some conditions become true. The monitoring aids 318 may dynamically display information about vehicles that may require operator intervention. The monitoring aids 318 may: periodically grab the operator's attention toward the missions focusing their attention on relevant information, relieve the operator from performing demanding computations to get the information required to support the decision-making, and present a relevant set of data to be evaluated by the operator in order to decide whether or not any action is required.

For example, conditions corresponding to when monitoring aids 318 may become active may include reduced automation and increased energy use. A vehicle's level of automation may be reduced (e.g., flight guidance control mode vs. autonomous navigation). Consequently, additional actions from the operator may be required. With respect to increased energy use, a vehicle may be using more energy than planned (e.g., holding patterns, numerous altitude or heading changes), which may be detected by the MMPM system 105-1. Consequently, the operator's decision-making may be necessary. The MMPM system 105-1 may estimate and cause indication of how much remaining flight time and/or distance the battery levels will allow. Due to limited battery energy availability, this element may be coupled with an energy management user interface conveying relevant information.

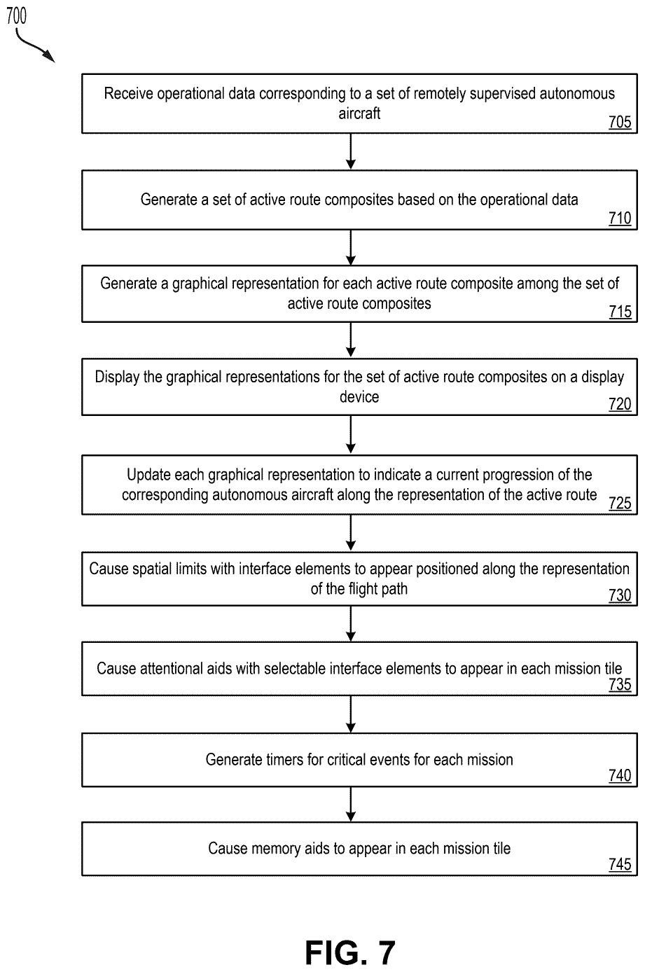

FIG. 7 illustrates one example method 700 for facilitating supervision of operations of remotely supervised autonomous aircraft, in accordance with embodiments according to the present disclosure. One or a combination of the aspects of the method 700 may be performed in conjunction with one or more other aspects disclosed herein, and the method 700 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 705, operational data corresponding to a set of one or more remotely supervised autonomous aircraft may be received by the MMPM system 105-1. In some embodiments, the MMPM system 105-1 may obtain operational data from diverse sources, including telemetry feeds from navigation and telemetry module 164, status messages from flight management system 162, and/or external feeds from ATC integration module 170. The operational data may include, for example, telemetry, real-time aircraft position, flight phase, mission configuration and parameters, automation state information, sensor outputs, spatial and temporal triggers, and communications status. In some embodiments, this data may be aggregated by telemetry receiver and aggregator 172, which may support both periodic and event-driven data updates. In some embodiments, operational data may also include detected anomalies, predicted trajectory deviations, and energy consumption metrics, enabling the MMPM system 105-1 to maintain a comprehensive and up-to-date operational picture for each aircraft. The receipt of operational data may be performed continuously or at defined intervals, depending on communication bandwidth and operational requirements.

As indicated by block 710, a set of one or more active route composites may be generated based at least in part on the operational data. Each active route composite may include data structures reflecting the current mission state, route information, and associated events for a particular aircraft among the set of remotely supervised autonomous aircraft. In some embodiments, upon receiving operational data, the MMPM system 105-1 (e.g., the mission analytics and computation engine 174) may be configured to process and synthesize the information to generate a set of active route composites. Each active route composite 310 may correspond to a unique mission currently assigned to a remotely supervised autonomous aircraft. The generation process may include mapping each flight's current position and planned trajectory, extracting route geometry and waypoints, and associating relevant temporal and spatial thresholds. The MMPM system 105-1 may utilize modular algorithms to identify which aircraft are active, determine their respective routes, and instantiate a graphical composite for each. The composites may be dynamically adjusted as missions are initiated, completed, or modified, ensuring that the set accurately reflects the current operational state.

As indicated by block 715, a graphical representation for each active route composite among the set of one or more active route composites may be generated. For each active route composite, the user interface generator 178 may generate a visually uniform graphical representation, as described with respect to MMPM UI 300. Each graphical representation may include an aircraft identifier 302 (e.g., callsign or unique vehicle ID) and a representation of the active route 306 associated with the corresponding autonomous aircraft. The route representation may be rendered as a straight line or scaled path within a mission tile, with the path's length either standardized or proportionate to the route's actual spatial or temporal length. Additional visual elements—such as spatial limits 314, aircraft progression indicator 308, memory aids 316, and monitoring aids 318—may be included as part of the representation, enhancing situational awareness and facilitating efficient monitoring by the operator. For example, monitoring aids 318 with interface elements may be caused to appear in each mission tile as the aircraft and its aircraft progression indicator 308 experience off-nominal conditions, such as reduced automation levels or increased energy usage, that may require operator monitoring or intervention if certain conditions become true. In some embodiments, the MMPM system 105-1 may also allow user customization of display elements, such as the selection of vertical or horizontal route orientations and the inclusion of contextual overlays.

As indicated by block 720, the one or more graphical representations for the set of one or more active route composites may be displayed on a display device. The graphical representations may each include a mission tile with a uniform background and a line representing the active route. The MMPM UI 300 may render all generated graphical representations on one or more output devices, such as monitors or touchscreens at the GCS 108 or supervisory workstation. The MMPM UI 300 may be designed for clarity and rapid comprehension, enabling the operator to view, at a glance, the status and progression of each mission. Mission tiles may be user-selectable, allowing the operator to access additional contextual data and controls for each mission. The display may be dynamically updated periodically or in real time as new operational data is received, ensuring that the information presented remains accurate and actionable. The MMPM system 105-1 may support multi-modal interaction with any suitable input device and may adapt the layout to accommodate varying numbers of concurrent missions.

As indicated by block 725, each graphical representation may be updated periodically or in real time to indicate a current progression of the corresponding autonomous aircraft along the representation of the active route. For example, the aircraft progression indicator 308 within each mission tile may be dynamically moved along the route 306 according to the aircraft's actual progression based on telemetry data such as ground speed, current position, and mission phase—according to a flight path scale that represents a relationship between a distance along the flight path represented within the mission tile and a corresponding distance along the flight path that the corresponding autonomous aircraft is to travel for its mission. Thus, the indicator's movement may be scaled to reflect a direct mapping between the graphical path and the underlying flight path, allowing the operator to intuitively gauge how far along the mission each aircraft is at any given moment. Updates may occur at regular intervals or in response to specific triggers (e.g., crossing a waypoint or entering a new mission phase). The MMPM system 105-1 may also update related visual elements—such as timers, spatial limits, and attentional aids—based on progression and operational context.

As described above, the graphical representations may be visually uniform. To minimize cognitive load and facilitate rapid comparison, each mission tile and associated graphical representation may be rendered with visually consistent backgrounds, route depictions, and interface elements. Uniformity may extend to the sizing, color schemes, iconography, and layout of mission tiles, ensuring that differences between missions are highlighted only by contextually relevant information (such as aircraft progression, alerts, and identifiers). This design may support both vertical and horizontal orientations, as described with respect to the MMPM UI 300 and illustrated in various figures. Each mission tile may be user-selectable, permitting a ground supervisor to reveal contextual data about a mission corresponding to the mission tile and a corresponding autonomous aircraft of the set of one or more remotely supervised autonomous aircraft. The contextual data may include task lists, flight plans, and other mission-specific information.

As indicated by block 730, one or more spatial limits with selectable interface elements may be caused to appear positioned along the representation of the flight path when operational data or mission parameters indicate that the aircraft is approaching or has reached a predefined spatial threshold, such as an initial approach fix, waypoint, or airspace boundary, requiring the attention of a ground supervisor. For example, spatial limits 314, such as initial approach fixes, airspace boundaries, or critical waypoints, may be graphically depicted along each route representation at positions scaled to the actual flight path. These interface elements may be user-selectable, enabling the operator to access detailed information about the nature and significance of each limit. The MMPM system 105-1 may dynamically update the position of these limits based on real-time operational data or mission modifications and may provide visual or auditory cues as aircraft approach these points. For example, the spatial limits may be dynamically updated in real time based on telemetry data, flight management system outputs, or air traffic control directives, and may be visually aligned along the active route composite 306 in the MMPM UI 300 according to a flight path scale. The selectable interface elements may be configured to provide additional contextual information or options for operator interaction—such as displaying more details about the spatial limit or enabling supervisory actions—when selected by the user. This may enable rapid assessment and timely intervention as the aircraft progresses through critical spatial regions along its mission route.

As indicated by block 735, one or more attentional aids with selectable interface elements may be caused to appear in each mission tile when a particular time is approaching for an action to be taken in the corresponding mission. For example, the MMPM system 105-1 may continuously monitor both spatial and temporal conditions, triggering attentional aids 312 as predefined thresholds are approached. The attentional aids may also be triggered based on mission-specific conditions, such as the detection (e.g., by the mission analytics and computation engine 174) of off-nominal events (e.g., route deviations, automation downgrades/changes, unexpected energy consumption), dynamic operational contexts, or any suitable user-defined criteria relevant to the operational context. For instance, if a vehicle's automation level drops, an attentional aid may be displayed immediately to prompt closer supervision or intervention by the operator. These aids may take the form of countdown timers, color changes, flashing indicators, or audible alerts, all designed to capture the operator's attention and prompt timely action—such as communication with ATC, issuing flight commands, or confirming task completion. The appearance, escalation, and dismissal of attentional aids may be governed by operational rules, user settings, or mission-specific logic, with the goal of reducing the risk of missed or delayed actions.

As indicated by block 740, one or more timers for critical events may be generated for each mission. The MMPM system 105-1 may instantiate and manage multiple timers for each mission, associated with critical events such as handoff windows, required communications, or imminent spatial thresholds. The timers may be activated based on spatial triggers and/or temporal triggers and may trigger visual and/or audible alerts when approaching deadlines for operator action. Timers may be dynamically updated based on real-time progression and may be displayed within the mission tiles as part of the attentional aids 312. As deadlines approach, the system may escalate alerts by modifying visual properties (e.g., color changes, flashing), increasing the salience of the timer, and optionally activating audible alerts. These features may relieve the operator of the cognitive burden of manual time tracking, reduce errors, and support timely decision-making.

As indicated by block 745, one or more memory aids with selectable interface elements may be caused to appear in each mission tile. The memory aids may visually represent completed tasks and/or pending tasks associated with each mission, supporting operator awareness and reducing cognitive load. For example, memory aids 316 may be displayed as icons, checklists, or progress markers within each mission tile, indicating the status of predictable tasks such as ATC clearances, preflight checks, or inflight communications. The operator may interact with these aids to mark tasks as completed, review pending actions, or access further details. By providing an externalized memory structure, the system may reduce the operator's working memory load, prevent task repetition, and mitigate the risk of missed actions. The MMPM system 105-1 may also provide context-sensitive display of memory aids—showing only those tasks that are relevant to the current mission phase or operational context.

The MMPM system 105-1 may continue to receive updated operational data, update the active route composites and associated graphical representations, and provide real-time or near-real-time supervisory decision support to the operator via the MMPM UI 300. It should be appreciated that one or more of the steps described herein may be omitted or the order of the steps may be modified, as desired. The described method may be executed using the MMPM system 105-1, computer system 700, and associated subsystems, and may include additional steps, modules, or user interactions as appropriate for the operational context.

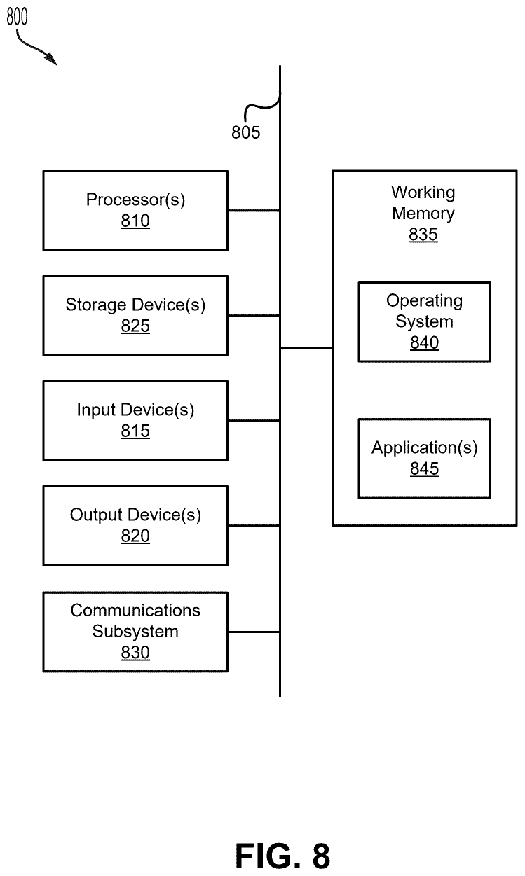

FIG. 8 illustrates aspects of a computer system 800 that may be incorporated as part of the MMPM system 105-1, the MVSS, the GCS 108, and/or other components that facilitate the MMPM UI 300, in accordance with embodiments of this disclosure. The computer system 800 may be configured to generate and update the MMPM UI 300, including the visual representation, count-down timers, attentional aids, memory aids, and monitoring aids in response to real-time operational data. The computer system 800 may receive data from sensors, flight management systems, and other sources to ensure the MMPM UI 300 accurately reflects the current operational state.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, video decoders, and/or the like); one or more input devices 815, which can include without limitation a mouse, a keyboard, remote control, and/or the like; and one or more output devices 820, which can include without limitation a display device, a printer, and/or the like.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. The communications subsystem 830 may permit data to be exchanged with a network (such as the network described below, to name one example), other computer systems, and/or any other devices described herein. In many embodiments, the computer system 800 will further comprise a working memory 835, which can include a RAM or ROM device, as described above.

The computer system 800 also can comprise software elements, shown as being currently located within the working memory 835, including an operating system 840, device drivers, executable libraries, and/or other code (e.g., to configure the computer system 800 to provide for embodiments disclosed herein), such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code, including instructions and/or code to configure the computer system 800 to provide for embodiments disclosed herein, may be stored on a non-transitory computer-readable storage medium, such as the non-transitory storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

As mentioned above, in one aspect, some embodiments may employ a computer system (such as the computer system 800) to perform methods in accordance with various embodiments. According to a set of embodiments, some or all of the procedures of such methods are performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the non-transitory storage device(s) 825. Merely by way of example, execution of the sequences of instructions contained in the working memory 835 might cause the processor(s) 810 to perform one or more procedures of the methods described herein.

The terms “machine-readable medium,” “computer-readable storage medium,” “computer-readable medium,” “processor-readable storage medium,” “processor-readable medium,” and plural forms thereof as used herein, refer to any medium or media that participate in providing data that causes a machine to operate in a specific fashion. These media may be non-transitory. In an embodiment implemented using the computer system 800, various computer-readable media might be involved in providing instructions/code to processor(s) 810 for execution and/or might be used to store and/or carry such instructions/code. In many implementations, a computer-readable medium is a physical and/or tangible storage medium. Such a medium may take the form of non-volatile media or volatile media. Non-volatile media include, for example, optical and/or magnetic disks, such as the non-transitory storage device(s) 825. Volatile media include, without limitation, dynamic memory, such as the working memory 835.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800.

The communications subsystem 830 (and/or components thereof) generally will receive signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a non-transitory storage device 825 either before or after execution by the processor(s) 810.

It should further be understood that the components of computer system 800 can be distributed across a network. For example, some processing may be performed in one location using a first processor while other processing may be performed by another processor remote from the first processor. Other components of computer system 800 may be similarly distributed. As such, computer system 800 may be interpreted as a distributed computing system that performs processing in multiple locations. In some instances, computer system 800 may be interpreted as a single computing device, such as a distinct laptop, desktop computer, or the like, depending on the context.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the embodiments. Rather, the preceding description of the embodiments will provide those skilled in the art with an enabling description for implementing embodiments of the embodiments. Various changes may be made in the function and arrangement of elements without departing from the spirit and scope of the embodiments.

Having described several embodiments, it will be recognized by those of skill in the art that various modifications, alternative constructions, and equivalents may be used without departing from the spirit of the embodiments. For example, the above elements may merely be a component of a larger system, wherein other rules may take precedence over or otherwise modify the application of the embodiments. Also, a number of steps may be undertaken before, during, or after the above elements are considered. Accordingly, the above description should not be taken as limiting the scope of the embodiments.

What is claimed:

1. A system to facilitate supervising aircraft operations of remotely supervised autonomous aircraft, the system comprising:
one or more processing devices; and
memory communicatively coupled with and readable by the one or more processing devices and having stored therein processor-readable instructions which, when executed by the one or more processing devices, cause the system to perform operations comprising:
receiving operational data corresponding to a set of remotely supervised autonomous aircraft;
generating a set of active route composites based at least in part on the operational data;
generating a graphical representation for each active route composite among the set of active route composites, wherein the graphical representation includes an aircraft identifier of a corresponding autonomous aircraft among the set of remotely supervised autonomous aircraft and a representation of an active route associated with the corresponding autonomous aircraft; and
transmitting the graphical representations for the set of active route composites to a display device to be displayed on the display device, wherein each graphical representation is updated to indicate a current progression of the corresponding autonomous aircraft along the representation of the active route, and wherein the graphical representations are visually uniform.

2. The system to facilitate supervising aircraft operations of remotely supervised autonomous aircraft as recited in claim 1, wherein the graphical representation of the active route comprises a flight path represented with a predetermined length within a mission tile.

3. The system to facilitate supervising aircraft operations of remotely supervised autonomous aircraft as recited in claim 2, wherein each mission tile is user-selectable to reveal contextual data about a mission corresponding to the mission tile and a corresponding aircraft of the set of remotely supervised autonomous aircraft.

4. The system to facilitate supervising aircraft operations of remotely supervised autonomous aircraft as recited in claim 1, wherein each graphical representation comprises a mission tile displaying an aircraft progression indicator that indicates a progression of a corresponding autonomous aircraft of the set of remotely supervised autonomous aircraft along the representation of the active route.

5. The system to facilitate supervising aircraft operations of remotely supervised autonomous aircraft as recited in claim 1, wherein each graphical representations comprises an aircraft progression indicator that moves along the representation of the active route according to a flight path scale that represents a relationship between a distance along a flight path represented with a predetermined length and a corresponding distance along the flight path that the corresponding autonomous aircraft is to travel for a corresponding mission.

6. The system to facilitate supervising aircraft operations of remotely supervised autonomous aircraft as recited in claim 1, the operations further comprising:
causing one or more spatial limits with interface elements to appear positioned along a representation of a flight path, wherein the one or more spatial limits correspond to one or more limits along the flight path that require attention of a ground supervisor.

7. The system to facilitate supervising aircraft operations of remotely supervised autonomous aircraft as recited in claim 1, the operations further comprising:
causing one or more attentional aids with interface elements to appear in a mission tile when a particular time is approaching for an action to be taken in a corresponding mission.

8. The system to facilitate supervising aircraft operations of remotely supervised autonomous aircraft as recited in claim 1, the operations further comprising:
causing one or more attentional aids with interface elements to appear in a mission tile based on mission-specific conditions.

9. The system to facilitate supervising aircraft operations of remotely supervised autonomous aircraft as recited in claim 1, the operations further comprising:
generating one or more timers for critical events for a corresponding mission, wherein the one or more timers are activated based on spatial triggers and/or temporal triggers, and the one or more timers trigger visual and/or audible alerts when approaching deadlines.

10. The system to facilitate supervising aircraft operations of remotely supervised autonomous aircraft as recited in claim 1, the operations further comprising:
causing one or more memory aids with interface elements to appear in a mission tile, wherein the one or more memory aids visually represent completed tasks and/or pending tasks associated with a corresponding mission.

11. The system to facilitate supervising aircraft operations of remotely supervised autonomous aircraft as recited in claim 1, wherein each graphical representation comprises a uniform background and a line representing the active route.

12. The system to facilitate supervising aircraft operations of remotely supervised autonomous aircraft as recited in claim 11, wherein a dimension of the line is proportionate to a spatial or temporal length of the active route.

13. A method to facilitate supervising aircraft operations of remotely supervised autonomous aircraft, the method comprising:
receiving operational data corresponding to a set of remotely supervised autonomous aircraft;
generating a set of active route composites based at least in part on the operational data;
generating a graphical representation for each active route composite among the set of active route composites, wherein the graphical representation includes an aircraft identifier of a corresponding autonomous aircraft among the set of remotely supervised autonomous aircraft and a representation of an active route associated with the corresponding autonomous aircraft; and
displaying the graphical representations for the set of active route composites on a display device, wherein each graphical representation is updated to indicate a current progression of the corresponding autonomous aircraft along the representation of the active route, and wherein the graphical representations are visually uniform.

14. The method to facilitate supervising aircraft operations of remotely supervised autonomous aircraft as recited in claim 13, wherein the graphical representation of the active route comprises a flight path represented with a predetermined length within a mission tile.

15. The method to facilitate supervising aircraft operations of remotely supervised autonomous aircraft as recited in claim 14, wherein each mission tile is user-selectable to reveal contextual data about a mission corresponding to the mission tile and a corresponding autonomous aircraft of the set of remotely supervised autonomous aircraft.

16. The method to facilitate supervising aircraft operations of remotely supervised autonomous aircraft as recited in claim 13, wherein each graphical representation comprises a mission tile displaying an aircraft progression indicator that indicates a progression of a corresponding autonomous aircraft of the set of remotely supervised autonomous aircraft along the representation of the active route.

17. The method to facilitate supervising aircraft operations of remotely supervised autonomous aircraft as recited in claim 13, wherein each graphical representation comprises an aircraft progression indicator that moves along the representation of the active route according to a flight path scale that represents a relationship between a distance along a flight path represented with a predetermined length and a corresponding distance along the flight path that the corresponding autonomous aircraft is to travel for a corresponding mission.

18. The method to facilitate supervising aircraft operations of remotely supervised autonomous aircraft as recited in claim 13, further comprising:
causing one or more spatial limits with interface elements to appear positioned along a representation of a flight path, wherein the one or more spatial limits correspond to one or more limits along the flight path that require attention of a ground supervisor.

19. The method to facilitate supervising aircraft operations of remotely supervised autonomous aircraft as recited in claim 13, further comprising:
causing one or more attentional aids with interface elements to appear in a mission tile when a particular time is approaching for an action to be taken in a corresponding mission.

20. One or more non-transitory, machine-readable media having machine-readable instructions thereon which, when executed by one or more processing devices, cause a system to perform operations comprising:
receiving operational data corresponding to a set of remotely supervised autonomous aircraft;
generating a set of active route composites based at least in part on the operational data;
generating a graphical representation for each active route composite among the set of active route composites, wherein the graphical representation includes an aircraft identifier of a corresponding autonomous aircraft among the set of remotely supervised autonomous aircraft and a representation of an active route associated with the corresponding autonomous aircraft; and
displaying the graphical representations for the set of active route composites on a display device, wherein each graphical representation is updated to indicate a current progression of the corresponding autonomous aircraft along the representation of the active route, and wherein the graphical representations are visually uniform.
